(19) United States
(12) Patent Application Publication
(10) Pub. No.: US 2014/0244485 A1
(43) Pub. Date: Aug. 28, 2014

(54) SYSTEMS AND METHODS FOR REMOTE ELECTRONIC COLLECTION OF PAYMENT

(71) Applicant: FISERV, INC., Brookfield, WI (US)

(72) Inventors: David Michael Keenan, Wilmette, IL (US); Carol Jackie Lucia Specogna, Bellingham, WA (US); Kevin Gilbert, Mukwonago, WI (US)

(73) Assignee: FISERV, INC., Brookfield, WI (US)

(21) Appl. No.: 13/780,627

(22) Filed: Feb. 28, 2013

(51) Int. Cl. G06Q 20/10

(52) U.S. Cl. CPC G06Q 20/108
USPC 705/39

(57) ABSTRACT

Systems and methods that receive one or more images or one or more information elements associated with a payment instrument in the form of a payment request. The payment request may be processed to identify a debit mechanism and a debit card account to which a credit is to be made. A debit transaction may be generated based at least in part on the payment request. A credit transaction may be generated based at least in part on the payment request and the debit card account.

### FIELD OF THE DISCLOSURE

The present disclosure relates to systems and methods for remote electronic collection of payments.

### BACKGROUND OF THE DISCLOSURE

There are currently financial systems that enable remote electronic collection of payments (also known as remote deposit capture), such as the deposit of a check using an image of the check captured at a location remote from a bank data center. This mechanism may entail a depositor (hereinafter also referred to as a user) taking a picture or an image scan of a physical check and using applications or software running on his/her computing device and transmitting the image to one or more computers associated with a financial institution in which the user holds a financial account. The financial institution, in turn, may procure and deposit funds associated with the check or other payment instrument based upon the transmission of the image of the check or other payment instrument.

### BRIEF DESCRIPTION OF THE FIGURES

Reference will now be made to the accompanying drawings, which are not necessarily drawn to scale, and wherein:

FIG. 1 is a simplified schematic diagram illustrating an example architecture for a remote electronic collection of payments in accordance with illustrative embodiments of the disclosure.

FIG. 2 is a simplified schematic diagram illustrating an example financial transaction system for remote electronic collection of payments in accordance with illustrative embodiments of the disclosure.

FIG. 3 is a simplified schematic diagram illustrating an example architecture for remote electronic collection of payments in accordance with illustrative embodiments of the disclosure.

FIG. 4 is a simplified schematic diagram illustrating an example client device for remote electronic collection of payments in accordance with illustrative embodiments of the disclosure.

FIG. 5 is a simplified schematic diagram illustrating an example service provider computer for remote electronic collection of payments in accordance with illustrative embodiments of the disclosure.

FIG. 6 is a simplified schematic diagram illustrating an example item processing computer for remote electronic collection of payments in accordance with illustrative embodiments of the disclosure.

FIG. 7 is a flow diagram illustrating an example method for remote electronic collection of payments in accordance with illustrative embodiments of the disclosure.

FIG. 8 is a simplified schematic representation of an example remote electronic collection of payments mechanism in accordance with illustrative embodiments of the disclosure.

### DETAILED DESCRIPTION OF EMBODIMENTS OF THE DISCLOSURE

Embodiments of the disclosure are described more fully hereinafter with reference to the accompanying drawings, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout.

Embodiments of the disclosure may provide systems and methods that enable remote electronic collection of payments, including remote deposit capture (RDC), into one or more financial accounts by a depositor. The remote electronic collection of payments may be enabled by a third-party entity and systems associated therewith. This third party system, in certain embodiments, may not be controlled by or even relatively tightly integrated with a financial institution and may interact with computer systems of various payment networks and/or financial institutions.

A merchant or depositor may interact with his/her client device such as a personal electronic device to interact with the third-party entity, such as a financial transaction system, to initiate the remote electronic collection of payments. The remote electronic collection of payments may entail at least a debit transaction and a credit transaction that are instantiated by the financial transaction system based, at least in part, on the input from the merchant via his/her client device. The debit transaction may reflect use of a variety of payment instruments such as a check, a debit card, a credit card, a pre-paid card, or an identification of any of a demand deposit account, a debit card account, a credit card account, or a pre-paid card account, or the like, and target any of a wide variety of associated financial accounts. In other words, a payor may provide any variety of payment instruments in providing payment to the merchant to complete the transaction. The payment instruments used for the transaction and provided to the merchant by the payor may be linked with one or more financial accounts from which funds may be withdrawn with the debit transaction. The financial account associated with the payment instrument and the payor may comprise any one of a debit card account, a demand deposit account, a credit card account, and/or a pre-paid card account. The credit transaction may be through a debit network, leveraging a debit card account associated therewith and issued to the merchant performing the transaction via the financial transaction system. On the credit transaction side, funds may be deposited in a financial account associated with the debit card and/or the merchant, such as a demand deposit account (DDA) or savings account. The debit transaction may be to provide funds to an entity associated with the financial transaction system, while the credit transaction may use funds of the entity associated with the financial transaction system to credit the merchant.

The merchant using his/her client device may capture i) one or more images of the payment instrument as provided by the payor to the merchant and/or ii) one or more payment instrument information elements associated with the payment instrument. Capturing the one or more payment instrument information elements may entail use of a user interface (by either the merchant or the payor) for entering and/or receiving the one or more payment instrument information elements, based at least in part, on the payment instrument of the payor. For example, if the payor provides a check as payment to the merchant then the merchant may use his/her client device to capture one or more images of that check, or portions thereof. In another example, if a payor provides a credit card to the merchant for payment then the merchant may use a variety of devices such as a card swipe apparatus associated with his/her client device to capture one or more information elements associated with the credit card provided by the payor. In some cases, the client devices may be configured to determine and/or extract one or more information elements associated with the payment instrument, based at least in part one or more images of the payment instrument, or portions thereof. Upon capturing one or more images and/or one or more information elements associated with the payment instrument, the client device may perform a variety of functions such as image analysis and image modification on the one or more images and provide those one or more images and/or one or more information elements to the financial transaction system to enable the remote electronic collection of payments associated with the payment instrument.

The financial transaction system may be a third-party system that is independent of the financial institutions of either the payor or the merchant. The financial transaction system may have one or more entities and systems associated therewith. In certain embodiments, the financial transaction system may include service provider computers and item processing computers. Each of the one or more service provider computers and the one or more item processing computers providing a variety of disparate or overlapping functionality in performing the remote electronic collection of payments. The service provider computers may receive the images and/or information associated with the payment instrument from the client device for performing the electronic collection of payment. The one or more images and/or information associated with the payment instrument may be sent by the client device and received by the service provider computers as part of a deposit or payment request. Therefore, the client device may generate and transmit the payment request to the service provider computers. Upon receiving the one or more images or information elements the service provider computers may identify the debit mechanism associated with the payment instrument. In other words, the service provider computers may determine what type of financial account is to be debited and a payment instrument form (if relevant). Upon identifying the debit mechanism, the service provider computers may identify the merchant debit card account. This may be performed by accessing one or more databases that associate particular merchants with their debit card accounts and/or financial accounts associated with merchant debit cards serviced by the service provider computers and the entities associated therewith.

Next, an optional risk assessment may be performed by the service provider computers. This risk assessment may entail determining the probability of bringing the debit transaction to completion with a sufficient level of funds transferred. The risk assessment may be performed to assess and/or reduce the risk of the entity associated with the service provider computers of not receiving funds form the debit transaction, while performing the credit transaction. In some cases, the risk assessment may be performed by the service provider computers in cooperation with other entities, such as one or more payment processor computers and/or financial institution computers. In the same or other cases, the risk assessment may consider historical transaction information or other historical data associated with the payor and/or the merchant. For example, if a particular payor is identified as having a fund insufficiency in a previous transaction, then other payment requests that are associated with that payor may be assessed to have a relatively higher level of risk associated therewith.

The service provider computers may further implement a variable debit delay. This may be an optional process in which the debit transaction associated with the funds transfer may be delayed by a predetermined period of time. The service provider computers may then generate a debit transaction which may incorporate at least one of the received one or more images and/or one or more information elements associated with the payment instrument. The service provider computers may transmit the generated debit transaction to the item processing computers or payment processor computers after the predetermined period of time has passed. Alternatively, the debit transaction may also indicate any variable debit delay that may be implemented for the item processing computers or payment processor computers to implement the delay. The generated debit transaction may then be transmitted to the item processing computers or payment processor computers without waiting the predetermined period of time.

The item processing computers may further implement a validation of the payment instrument, potentially in cooperation with one or more other entities such as the payor's financial institution computers. The item processing computers may then initiate a debit instruction upon validation of the payment instrument. The item processing computers may use the same debit transaction generated by the service provider computers or a variant of the debit transaction generated by the service provider computers. The item processing computers may transmit the debit instruction to a financial institution or an automated clearing house (ACH) networks.

The service provider computers may implement a variable credit delay. This variable credit delay may entail delaying the credit of the merchant's debit card account by a period of time based on at least one of a pre-established determination, a dynamically calculated determination, or an event, such as a response associated with the debit transaction. In some cases, the variable credit delay may be implemented to mitigate risks associated with the remote electronic collection of payments such as risks that have been assessed by the service provider computers, item processing computers, and/or payment processing computers prior to executing the crediting portion of the remote electronic collection of payments. The service provider computers may next generate a credit transaction based upon information elements associated with the debit card account such as the debit card personal account number (PAN), the debit card personal identification number (PIN), an identification of the merchant, the amount to be credited based on the amount of the payment request, any credit delays, or the like. Note that the service provider computers may implement the credit delay prior to transmitting the credit transaction or may have the recipient of the credit transaction implement the credit delay.

Next, the service provider computers may transmit the credit transaction to debit network computers associated with any suitable entity, such as a debit card network, for fulfilling a debit card-based credit transaction. The service provider computers may further optionally obtain a debit card account balance after remote electronic collection of payments, and transmit the debit card account balance to the client device for presentation to the merchant.

In certain embodiments, the systems and methods of the disclosure may enable payment using a variety of accounts and payment instruments such as credit cards, debit cards, demand deposit accounts, checks and/or pre-paid cards. Additionally, the systems and methods in accordance with embodiments of the disclosure may enable the deposit of funds associated with the financial transaction via a debit card account. Further still, the systems and methods of the embodiments of the disclosure may be third-party systems that are not part of the financial institutions of either the merchant or the payor. Therefore, the system such as the financial transaction system, the service provider computers, the item processing computers, and/or the payment processing computers may be delinked from being controlled by or tightly integrated with the financial institutions that control the financial institution computers of the payor and/or the merchant. These third party systems may facilitate remote electronic collection of payments associated with a variety of financial institutions, payment instruments, funds clearing mechanisms, and/or payment instrument networks.

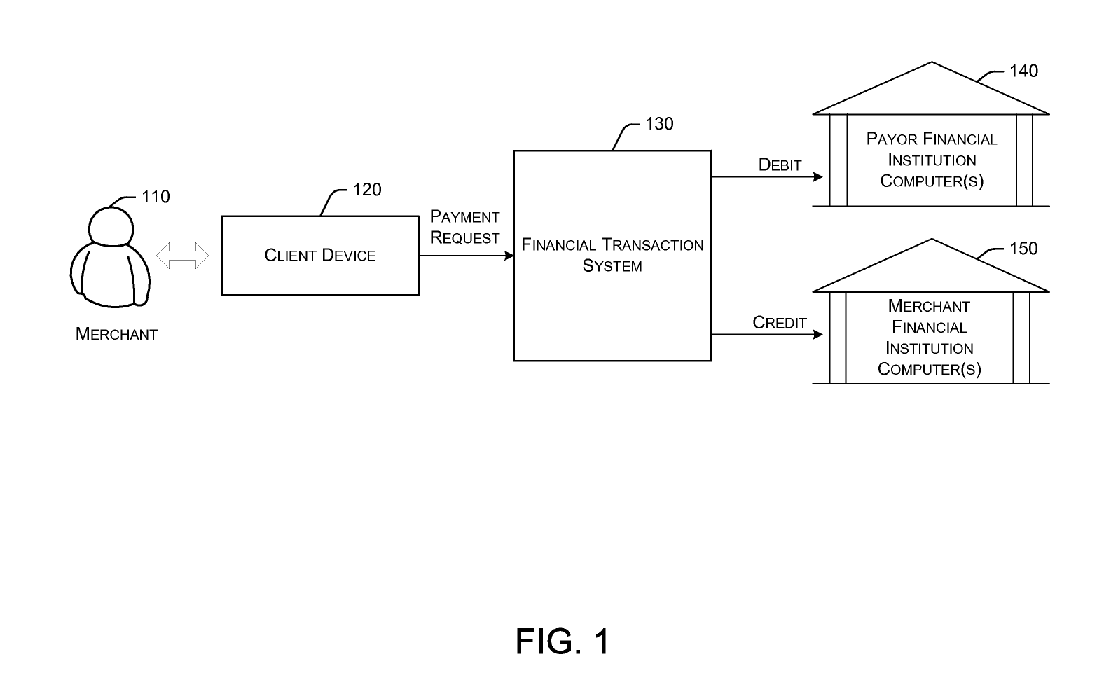

Referring now to FIG. 1, an example architecture 100 for remote deposit capture and remote electronic collection of payments in accordance with embodiments of the disclosure is disclosed. As depicted, a merchant, depositor, and/or payee 110 may interact with his/her client device 120 to initiate the process of remote electronic collection of payments. The merchant 110 may receive a payment instrument such as a check, a credit card, a debit card, or a pre-paid card as a payment mechanism and may wish to deposit that payment in his/her financial account. The merchant 110 may capture one or more images of the payment instrument using his/her client device 120. Additionally or alternatively, the merchant 110 may capture and/or enter one or more information elements associated with the payment instrument into his/her client device 120.

The merchant 110 may be any individual or entity configured to receive payment. In the context of this disclosure, the merchant 110 may be any suitable entity that may acquire and/or use remote electronic collection of payments services, including individuals, organizations, corporations, non-profit organizations, or the like. In certain embodiments, the merchant may be preregistered to receive payment via his/her debit card account.

The client device 120 may be any suitable electronic device or personal user device such as a laptop computer, a netbook computer, a smartphone, an e-book reader, a personal digital assistant, a tablet computing device, or the like. In some cases, the client device 120 may be an “intelligent device” that may execute one or more programs and user applications locally on processor(s) of the client device 120 to perform functions associated with remote electronic collection of payments, such as image processing. In many cases, various functions of the remote electronic collection of payments may be performed in a thick client mode on the client device 120. In other cases, the client device 120 may be substantially a “dumb terminal” configured to primarily execute software, programs, or user applications related to serving, displaying, or otherwise rendering information or content provided from sources external to the client device 120, such as rendering displays associated with other entities of the architecture 100.

The client device 120, therefore, may execute one or more instructions and/or applications to enable the remote electronic collection of payments and to execute the functionality associated therewith. Accordingly, the client device 120 may be configured using both hardware and/or software to capture one or more images of the payment instrument and/or capture one or more information elements associated with the payment instrument. The client device 120 may further be configured to perform a variety of image processing tasks associated with one or more images of the payment instrument. These image processing tasks and/or processes may include, but is not limited to, image filtering, image sharpening, modifying the orientation of the image, modifying the dithering of one or more pixels associated with the image, modifying the contrast of the image, modifying the brightness of the image, processing metadata associated with the one or more images, image field recognition, text sequence recognition, optical character recognition (OCR), and/or intelligent character recognition (ICR), or combinations thereof.

In certain embodiments, the client device 120 and applications running thereon may be configured to extract one or more payment instrument information elements from the one or more images associated with the payment instrument. For example, the client device 120 may be configured by any combination of hardware and/or software to extract an identification of a payment instrument type, an identification of the payor's address, an identification of the payor's telephone number, an identification of the payor's financial account number, an identification of a financial account number, an identification of a routing number on a check, an identification of a check number, an expiration date of a credit card or debit card, a card verification string of a credit card, a card type of a credit or debit card, a card association, a card issuer and/or combinations thereof. Upon receiving and/or assembling the appropriate one or more images and/or one or more information elements associated with the payment instrument, the client device 120 may generate a payment request or deposit request based, at least in part, on the one or more images and/or the one or more information elements associated with the payment instrument. The client device 120 may then transmit the payment request to a financial transaction system 130 on behalf of the merchant 110.

The financial transaction system 130 may receive the payment request from the client device 120 and may process the payment request to determine a variety of factors that may be subsequently used to initiate the transaction associated with the payment request. The financial transaction system may be configured to identify the merchant 110 based, at least in part, on the received payment request from the client device 120 and identify a debit card account associated with the merchant 110. This may be accomplished by the financial transaction system 130 by accessing a merchant profile in an appropriate data repository. The financial transaction system 130 may further identify the debit mechanism associated with the payment request. The debit mechanism may be ascertained by analyzing the one or more images and/or the one or more information elements associated with the payment instrument and received as part of the payment request from the client device 120.

Upon identifying the debit mechanism, the financial transaction system 130 may perform a risk assessment associated with the debit mechanism and/or the payment instrument associated therewith. The financial transaction system 130 may further implement a variable debit delay by a pre-determined time period in which the debit transaction is held prior to execution or transmission. Based, at least in part, on the received payment request, the financial transaction system may generate a debit transaction and may transmit that debit transaction to a payment network and ultimately to a payor financial institution computers 140.

The financial transaction system 130 may further be configured to implement a variable credit delay for a pre-determined period of time. In some cases, the variable credit delay may be implemented as a result of potential risks in consummating the transaction. A credit transaction may be generated by the financial transaction system and transmitted via a payment network to the merchant financial institution computers 150.

As discussed above, financial transaction system 130 may be a third-party system that is independent of financial institutions that may control or own the payor financial institution computers, the merchant financial institution computers, or the debit or credit networks affiliated with each of the financial institutions. In certain embodiments, there may be more than one entity associated with and/or controlling the financial transaction system 130. For example, certain functionality associated with the remote electronic collection of payments may be performed by a first entity and another set of functionality associated with remote electronic collection of payments may be performed by another entity within the framework of the financial transaction system 130.

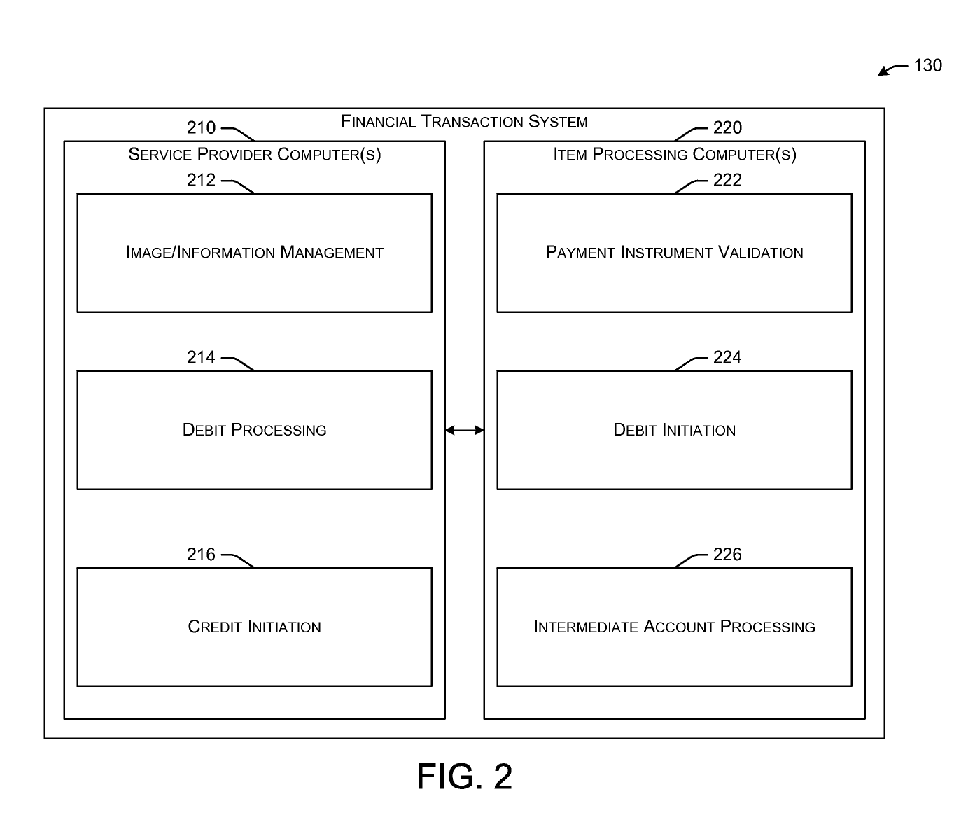

Referring now to FIG. 2, an example implementation of the financial transaction system 130 in accordance with embodiments of the disclosure is depicted. The financial transaction system 130 may include at least one or more service provider computers 210, and optionally one or more item processing computers 220 or other systems or computers, such as one or more payment processor computers 330. In this particular example implementation, the financial transaction system 130 comprises both the one or more service provider computers 210 and the one or more item processing computers 220. The service provider computers 210 and the item processing computers 220 may cooperate to provide the functionality of the financial transaction system 130. In certain embodiments, the service provider computers 210 and item process computers 220 may be controlled by the same entity. In other embodiments, the service provider computers 210 and the item processing computers 220 may be controlled by two different entities that cooperate with each other to provide remote electronic collection of payments functionality in accordance with embodiments of the disclosure.

The service provider computers 210 may have a variety of components associated therewith. These components may be implemented in hardware, software, and/or a combination of hardware and software. The components of the service provider computers 210 may include an image or information management component 212, a debit processing component 214 and a credit initiation component 216.

The image or information management component 212 may be configured to receive the one or more images and/or the one or more information elements from the client device 120 associated with the payment instrument. The received one or more images and/or the one or more information elements may further be stored locally or remotely from the service provider computers 210. The one or more images and/or the one or more information elements may further be used by the service provider computers to generate one or more debit transactions and/or credit transactions. Further still, the one or more images and/or one or more information elements associated with the payment instrument may be used by other service provide computers 210 components for identifying a debit mechanism, performing risk assessment associated with the payment request, including performing risk assessment in cooperation with other entities such as the payor financial institution computers 140, and/or determining one or more delays associated with a debit transaction or a credit transaction.

The debit processing component 214 may receive the payment request, determine a debit mechanism therefrom, and generate a debit transaction which may be transmitted from the service provider computers 210 to the item processing computers 220. The debit transaction may include an indication of type of payment instrument, an amount for the transaction, the name of a payor, a personal account number associated with the payor and/or the related financial account, a payor financial institution name, and/or the like. The debit processing component 214 may further enable implementing a debit delay associated with the debit transaction.

The credit initiation component 216 may enable processes to receive the payment request and identify a merchant therefrom, as well as a debit card account number associated with the merchant. The credit initiation component may further enable implementing a variable credit delay and risk assessment of the payment request and the associated transaction. The credit initiation component 216 may further provide functionality to generate a credit transaction and transmit the same to a debit card network to instantiate payment to the financial account associated with the merchant 110.

The item processing computers 220 may include a variety of components including payment instrument validation component 222, debit initiation component 224 and intermediate account processing component 226. The payment instrument validation component 222 may provide functionality that may leverage local or external data to confirm the validity of at least a portion of the payment instrument. The payment instrument validation component 222 may cooperate with other entities of architecture 100 such as the payor financial institution computers 140 to ascertain if the payment instrument is valid and/or determine a risk associated with consummating the transaction requested by the merchant 110. The payment instrument validation component 222 may provide further functionality associated with risk analysis and risk management of the remote deposit functionality.

The debit initiation component 224 may include functionality associated with initiating a debit instruction to a payment network as a result of receiving a debit transaction and processing the one or more images and/or one or more information elements associated therewith. The debit initiation component 224 upon receiving a debit transaction may be configured to generate a debit instruction and transmit the debit instruction to a payment network, such as an ACH network, a debit network, a credit card network, or to the financial institution associated with the payor and the computers 140 associated therewith. In some cases, an automated clearing house ACH debit may be initiated by the debit initiation component 224. The debit transaction may alternatively be in the form of, or may include, an image replacement document (IRD) and/or an X9.37 file. Therefore, the debit transaction may be transmitted in a variety of formats and/or forms on to a payment network for ultimate transmission to the payor financial institution computers 140.

The intermediate account processing component 226 may enable the transfer of funds from one intermediate account receiving the debited funds to another intermediate from which the credited funds are drawn. Using an intermediate account associated with a financial institution of the financial transaction system 130 may be especially useful if the item processing computers 220 and the service provider computers 210 are affiliated with and/or controlled by different entities.

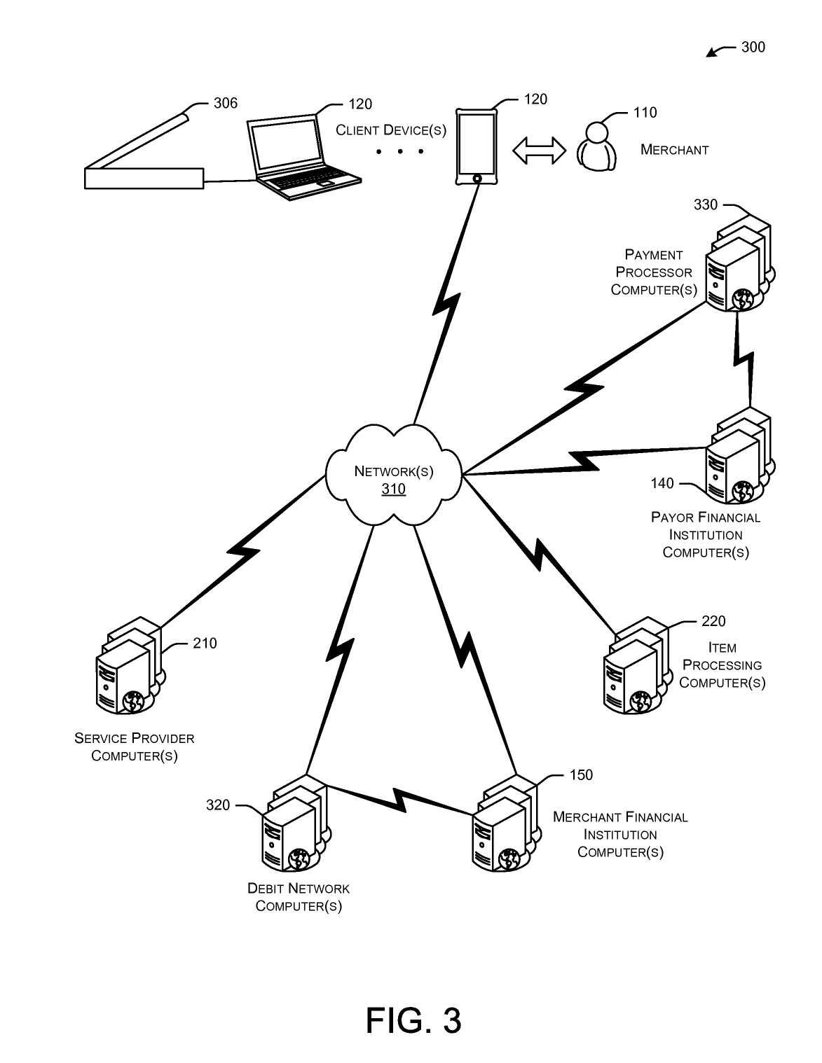

Referring now to FIG. 3, an example architecture 300 involved in the remote electronic collection of payments in accordance with embodiments of the disclosure is depicted. As shown, the merchant 110 may interact with his/her client device 120. The client device 120 may be communicatively coupled to other entities of architecture 300 via one or more networks 310. The client device 120 may have an input/output device 306 attached and/or communicatively linked thereto. The input/output device 306 may be any variety of suitable devices that may be utilized to provide one or more images of a payment instrument or one or more information elements associated with the payment instrument.

As shown, the input/output device 306 may be a flatbed scanner such as a printer, facsimile, scanner combination device. In other cases, the input/output device 306 may be any variety of devices that includes an image sensor such as a camera associated with a smartphone. Additionally, the input/output device 306 may be a card reader, a keypad/keyboard, a pointing device and keypad/keyboard display, or a touch screen with keypad/keyboard display that is used to enter one or more information elements associated with the payment instrument.

The networks 310 may include any one or a combination of different types of suitable communications networks, such as cable networks, the Internet, wireless networks, cellular networks, and other private and/or public networks. Furthermore the networks 310 may include any variety of medium over which network traffic is carried including, but not limited to, coaxial cable, twisted wire pair, optical fiber, hybrid fiber coaxial (HFC), microwave terrestrial transceivers, radio frequency communications, satellite communications, or combinations thereof.

The architecture 300 may further include the service provider computers 210, the item processing computers 220, the payor financial institution computers 140, and the merchant financial institution computers 150. The architecture 300 may yet further include debit network computers 320 and payment processor computers 330.

The debit network computers 320 may enable the credit on the merchant's debit card and associated financial account. The debit network computers 320 may receive a credit transaction from the service provider computers 210 and may route the credit transaction to the appropriate merchant financial institution computers 150. In some cases, the debit network computers 320 may use the one or more networks 310 or have direct communicative links with either or both of the merchant financial institution computers 150 and/or the service provider computers 210. The debit network computers 320 may be affiliated with any suitable network operator such as ACCEL®/Exchange, NYCE®, Pulse®, Star®, Visa®, MasterCard®, or the like.

The payment processor computers 330 may be communicatively linked via the one or more networks 310 or directly with the payor financial institution computers 140. The payment processor computers 330 may support processing associated with the debit transaction, e.g., when the debit transaction may encompass an ACH transaction, a credit card transaction, a debit card transaction or a pre-paid card transaction. The payment processor computers 330 may also or alternatively serve as an element in determining fund sufficiency of a financial account from which the payment instrument provided by the merchant 110 draws upon. Therefore, the item processing computers 220 may communicate with the payment processor computers 330 to determine if a payment has a relatively high likelihood of being fulfilled via a debit transaction on the payor financial institution computers 140 and the payor financial account associated with the payment instrument. Financial vs. non-financial messaging.

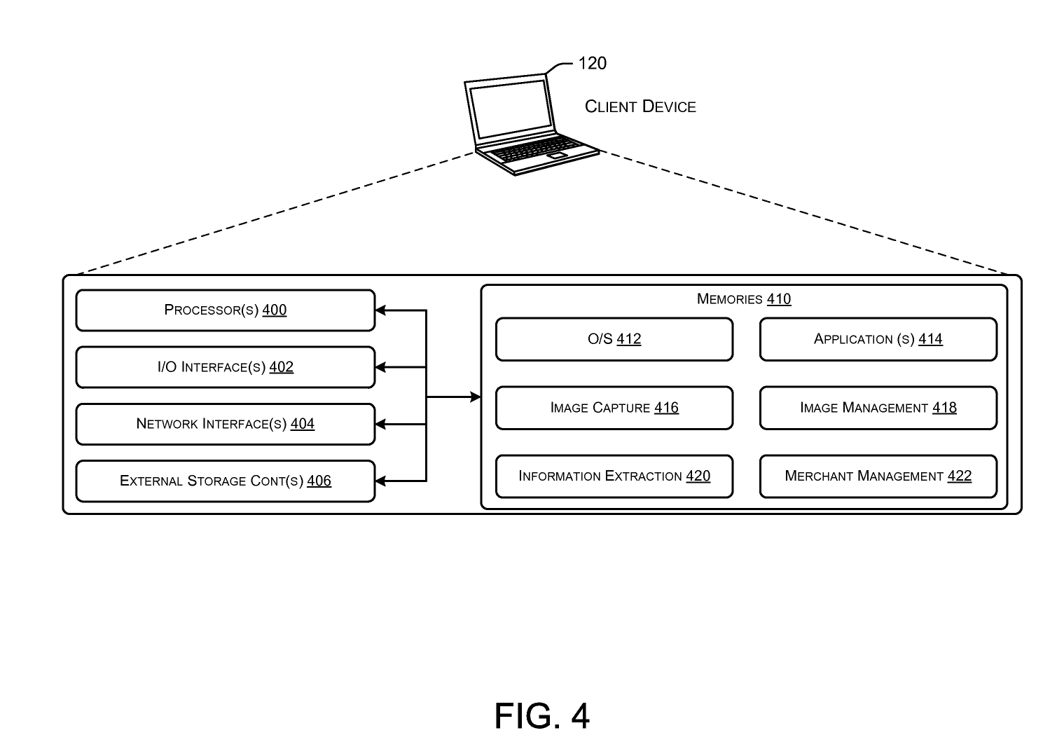

Referring now to FIG. 4, the client device 120 is described in accordance with embodiments of the disclosure. One or more of the functionality described in association with the client device 120 may be performed in a client-server configuration, where the client device 120 may communicate over the networks 310 or other suitable communicative links with a back-end server, such as the service provider computers 210. The client device 120 may include one or more processors 400, one or more I/O interfaces 402, one or more network interfaces 404 and one or more external storage controllers 406 and one or more memories 410. It will be appreciated that the client devices 120 may include other components or elements that enable the client devices 120 to perform the methods and processes described herein in accordance with embodiments of the disclosure.

The I/O interfaces(s) 402, may include any suitable interface configured to interface between the processors 400 and the components 306 of the client device 120. The I/O interfaces 402 may further enable interaction with a variety of user interface components to configure the client device 120 to receive merchant 110 input and/or render information to the merchant 110. The components may include, keyboards, touch screens, mice, haptic devices, speakers, microphones, monitors, accelerometers, or the like. The network interfaces(s) 404 may allow the client device 120 to communicate with other computing devices or servers, user terminals, and/or other devices on the networks 310 or other suitable communicative channels. The network interfaces(s) 404 may allow the client device 120 to communicate with stored databases. The external storage controllers 406 may enable the processors 400 to communicate with and/or control optional external data stores.

The one or more processors 400 may be configured to execute and/or operate one or more instructions, applications, and/or software in the one or more memories 410 of the client device 120 to provide services to the merchants 110 associated with the user device 120. The processors 400 may further be configured to receive input from or provide output to the components 306 and other components of the client device 120. For example, the processors 120 may be configured to direct the operation of the image scanner 306 and/or receive an image sensor signal and/or image sensor data associated with an image captured using the image scanner 306.

In some examples, the one or more processors 400 of the client device 120 may be implemented as appropriate in hardware, software, firmware, or combinations thereof. Software or firmware implementations of the one or more processors 400 may include computer-executable or machine-executable instructions written in any suitable programming language to perform the various functions described. Hardware implementations of the processors 400 may be configured to execute computer-executable or machine-executable instructions to perform the various functions described. The one or more processors 400 may include, without limitation, a central processing unit (CPU), a digital signal processor (DSP), a reduced instruction set computer (RISC), a complex instruction set computer (CISC), a microprocessor, a microcontroller, a field programmable gate array (FPGA), or any combination thereof. The client device 120 may also include a chipset (not shown) for controlling communications between the one or more processors 400 and one or more of the other components of the client device 120. The one or more processors 400 may also include one or more application specific integrated circuits (ASICs) or application specific standard products (ASSPs) for handling specific data processing functions or tasks.

The memory 410 may include one or more volatile and/or non-volatile memory devices including, but not limited to, random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read only memory (EEPROM), non-volatile RAM (NVRAM), universal serial bus (USB) removable memory, or combinations thereof. The memory 410 may store program instructions that are loadable and executable on the processor(s) 400, as well as data generated or received during the execution of these programs. Turning to the contents of the memory 410 in more detail, the memory 410 may include an operating system (O/S) module 412, an application's module 414, an image capture module 416, an image management module 418, an information extraction module 420 and a merchant management module 422. Each of the modules and/or software may provide functionality for the client device 120, when executed by the processors 400. The modules and/or the software may or may not correspond to physical locations and/or addresses in memory 410. In other words, the contents of each of the modules may not be segregated from each other and may, in fact be stored in at least partially interleaved positions on the memory 410. In certain embodiments, each of the modules 412, 414, 416, 418, 420, 422 may be divided with greater granularity. In other words, each of the modules 412, 414, 416, 418, 420, 422 may include sub-modules.

The O/S module 412 may have one or more operating systems stored thereon. The processors 180 may be configured to access and execute one or more of the O/S module 412 to operate the system functions of the client device 120. System functions, as managed by the O/S 412 may include memory management, processor resource management, driver management, application software management, system configuration, and the like. The O/S may be any variety of suitable operating systems including, but not limited to, Google® Android®, Microsoft® Windows®, Microsoft® Windows® Server®, Linux, Apple® OS-X®, Apple® iOS®, or the like. In other words, the O/S 412 may be the framework under which the merchant 110 may interact with the client device 120. The applications module 414 may have one or more software applications stored thereon that may be accessed and executed by the processors 400 to provide various functionality of the client device 120, including remote deposit related functionality.

The image capture module 416 may have instructions stored thereon that when executed by processors 400, enables the client device 120 to perform various functions associated with capturing an image such as an image of a payment instrument or portions thereof. The processors 400 may be configured to control one or more I/O devices such as the image scanner 306 or a camera to capture an image of the payment instrument. Therefore, the merchant 110 may use the client device 120 and components thereof for the capture of an image of the payment instrument. For example, the merchant 110 may take a picture of the front of a check or the front and back of a credit card.

The image management module 418 may have instructions stored thereon that when executed by processors 400, enable the client device 120 to perform a variety of tasks associated with management of images such as images of a payment instrument. The client device 120 and the processors 400 thereon may be configured to store in the memory 410 or an external storage device one or more images associated with the payment instrument that is used for performing a remote electronic collection of payments. The processors 400 may further be configured to access, at a future time, one or more stored images associated with a particular transaction or a particular remote electronic collection of payments. Furthermore, the processors may be configured to perform a variety of image modification processes such as image improvement methods. The image improvement methods may include changing the coloring, changing the resolution, changing the dithering, changing the brightness, changing the contrast or changing any variety of other aspects associated with one or more images as captured by the client device 120 and the processors 400 thereon. The image analysis, in certain embodiments, may be used to repair any defects in the received payment instrument image(s). For example, if a received payment instrument image has a lot of noise, or otherwise spots and/or streaks thereon, then filtering and/or dithering techniques may be used to reduce the level of noise in the image. As another example, if the image is skewed, or otherwise trapezoidal rather than rectangular, due to the angle of the image scanner 306 relative to the payment instrument while the payment instrument image was captured, then various techniques may be used to reduce the trapezoidal effect. Therefore, the image modification and/or enhancement techniques may further include, but are not limited to, image filtering, image sharpening, modifying an image orientation, processing metadata associated with the image, image field recognition, text sequence recognition, optical character recognition, intelligent character recognition, or combinations thereof.

The information extraction module 420 may have instructions stored thereon that when executed by processors 400, may enable the client device 120 to perform a variety of functions associated with extracting information from one or more images such as images of payment instruments. The extraction of the one or more information elements from images of payment instruments may enable the client device to provide the information elements that may be relevant in executing a deposit of funds in accordance with embodiments of the disclosure. The information extraction functions enabled by the instructions stored in the information extraction module 420 may configure the processors 400 to perform any variety of optical character recognition (OCR), intelligent character recognition (ICR), image field recognition, text sequence recognition, or other mechanisms of image analysis to extract information associated with a payment instrument and/or financial accounts associated therewith. The processors 400 may be configured to extract information from an image of a payment instrument such as an amount of the transaction, a personal account number (PAN) associated with the transaction, the type of payment instrument being used for the transaction, the name of the payor associated with the transaction, or the like. Additional payment instrument information that may be determined from one or more images of the payment instrument may include payer's identification, payer's address, fields and/or information associated with magnetic ink character recognition (MICR), such as a routing number, an account number, and the check number. The processors 400 may further be configured, by executing instructions stored in the information extraction module 420, to provide the one or more information elements associated with the payment instrument to the service provider computers 210 via networks 310 or other suitable communicative links.

Merchant management module 422 may have instructions stored thereon that enables the client device 120, when executed by the processors 400, to perform a variety of merchant and/or account management activities associated with the merchant 110. The processors may be configured to identify the merchant 110 such as using a login, password and/or a name. The merchant 110 may further be identified by a personal account number (PAN) associated with his/her debit card account. The merchant management module 422 may further provide instructions to the processor 400 to register the merchant's debit card and associated financial account with the service provider computers 210 by communicating with the service provider computers 210. In one aspect, the processors 400 may transmit an association of the merchant's identity associated with his/her PAN and/or other information elements associated with his/her debit card. When the merchant 110 uses his/her client device 120 to interact with the service provider computers 210 to perform a remote electronic collection of payments, the processors 400 may provide an identification of the merchant to the service provider computers so that the service provider computers can identify the appropriate debit card and associated financial account of the merchant 110.

It will be appreciated that there may be overlap in the functionality of the instructions stored in the operating system (O/S) module 412, the applications module 414, the image capture module 416, the image management module 418, the information extraction module 420 and the merchant management module 422. In fact, the functions of the three aforementioned modules 412, 414, 416, 418, 420, 422 may interact and cooperate seamlessly under the framework of the configuration servers 154. Indeed, each of the functions described for any of the modules 412, 414, 416, 418, 420, 422 may be stored in any other module 412, 414, 416, 418, 420, 422 in accordance with certain embodiments of the disclosure. Further, in certain embodiments, there may be one single module that includes the instructions, programs, and/or applications described within the operating system (O/S) module 412, the applications module 414, the image capture module 416, the image management module 418, the information extraction module 420 and the merchant management module 422.

It will be appreciated that, some of the functions described in association with the client device 120 may be implemented on the service provide computers, or in cooperation with the service provider computers 210 or other elements of architecture 300.

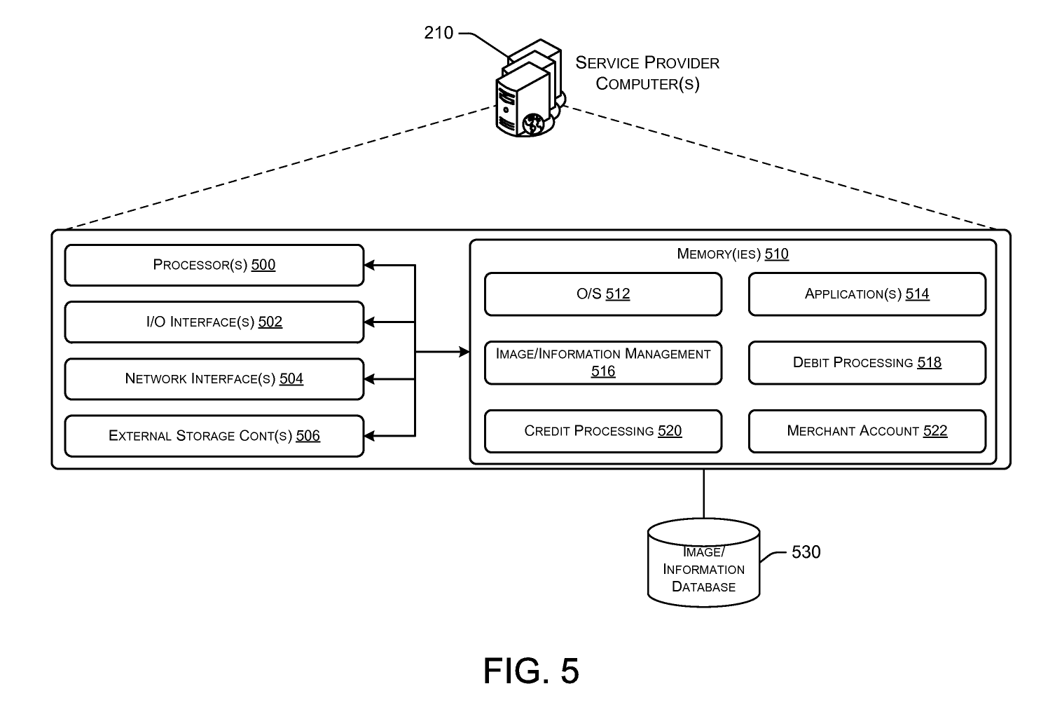

Referring now to FIG. 5, the service provider computers 210 are described. The service provider computers 210 may include one or more processors 500, one or more input/output interfaces 502, one or more network interfaces 504 and one or more external storage controllers 506 and one or more memories 510. It will be appreciated that the service provider computers 210 may include other components or elements that enable the service provider computers 210 to perform the methods and processes described herein in accordance with embodiments of the disclosure.

The I/O interfaces(s) 502, may include any suitable interface configured to interface between the processors 500 and any I/O interfaces of the service provider computers 210. The network interfaces(s) 504 may allow the service provider computers 210 to communicate with other computing devices or servers, user terminals, and/or other devices on the networks 310 or other suitable communicative channels. The network interfaces(s) 504 may allow the service provider computers 210 to communicate with stored databases. The external storage controllers 506 may enable the processors 500 to communicate with and/or control optional image/information database 530, where the processors may store one or more images and or information associated with payment instruments.

In some examples, the one or more processors 500 of the service provider computers 210 may be implemented as appropriate in hardware, software, firmware, or combinations thereof. Software or firmware implementations of the one or more processors 500 may include computer-executable or machine-executable instructions written in any suitable programming language to perform the various functions described. Hardware implementations of the processors 500 may be configured to execute computer-executable or machine-executable instructions to perform the various functions described. The one or more processors 500 may include, without limitation, a central processing unit (CPU), a digital signal processor (DSP), a reduced instruction set computer (RISC), a complex instruction set computer (CISC), a microprocessor, a microcontroller, a field programmable gate array (FPGA), or any combination thereof. The service provider computers 210 may also include a chipset (not shown) for controlling communications between the one or more processors 500 and one or more of the other components of the service provider computers 210. The one or more processors 500 may also include one or more application specific integrated circuits (ASICs) or application specific standard products (ASSPs) for handling specific data processing functions or tasks.

The memory 510 may include one or more volatile and/or non-volatile memory devices including, but not limited to, random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read only memory (EEPROM), non-volatile RAM (NVRAM), universal serial bus (USB) removable memory, or combinations thereof. The memory 510 may store program instructions that are loadable and executable on the processor(s) 500, as well as data generated or received during the execution of these programs. Turning to the contents of the memory 510 in more detail, the memory 510 may include an operating system module 512, an application's module 514, an image or information management module 516, a debit processing module 518, a credit indication module 520 and the merchant account module 522. Each of the modules and/or software may provide functionality for the service provider computers 210, when executed by the processors 500. The modules and/or the software may or may not correspond to physical locations and/or addresses in memory 510. In other words, the contents of each of the modules may not be segregated from each other and may, in fact be stored in at least partially interleaved positions on the memory 410. In certain embodiments, each of the modules 512, 514, 516, 518, 520, 522 may be divided with greater granularity. In other words, each of the modules 512, 514, 516, 518, 520, 522 may include sub-modules.

The O/S module 512 may have one or more operating systems stored thereon. The processors 500 may be configured to access and execute one or more of the O/S module 512 to operate the system functions of the service provider computers 210. System functions, as managed by the O/S 512 may include memory management, processor resource management, driver management, application software management, system configuration, and the like. The O/S may be any variety of suitable operating systems including, but not limited to, Google® Android®, Microsoft® Windows®, Microsoft® Windows® Server®, Linux, Apple® OS-X®, Apple® iOS®, or the like. In other words, the O/S 512 may be the framework under which the merchant 110 may interact with the service provider computers 210. The applications module 514 may have one or more software applications stored thereon that may be accessed and executed by the processors 500 to provide various functionality of the service provider computers 210, including remote deposit related functionality.

The information management module 516 may include instructions that when executed by processors 500, enable the service provider computers 210 to manage a variety of the one or more images and/or one or more information associated with the payment instrument as received from the client device 120. The images and/or information associated with the payment instruments may be stored in a database, such as the image/information database 530, associated with the service provider computers 210 or in the memory 510 and may subsequently be accessed during various processes performed by the service provider computers 210 on the one or more images or one or more information elements associated with the payment instrument.

The debit processing module 518 may include instructions therein that when executed by the processors 500, enable the service provider computers 210 to perform a variety of debit processing tasks. The processors 500 may be configured to receive the one or more images and/or the one or more information associated with the payment instrument and generate a debit transaction based thereon. The debit transaction may itself include a variety of information such as one or more of the received information associated with the payment instrument. Furthermore, in certain embodiments, such as when the payment instrument is a check, the processors 500 may include one or more images of the payment instrument as part of the debit transaction. The processors 500 may further be configured to transmit the debit transaction as generated to the item processing computers 220 to perform the debit transaction. In other embodiments, the processors 500 may be configured to generate a debit transaction associated with one of a demand deposit account, a credit card account, a debit card account, or a pre-paid card account, and transmit the debit transaction to appropriate payment processor computers 330 (e.g., associated with an ACH network, a debit network, or a credit card network) or payor financial institution computers 140.)

The credit processing module 520 may have instructions stored thereon that when executed by the processors 500, enable the service provider computers 210 to provide a variety of credit processing functionality including generating a credit transaction. The processors 500 may be configured to ascertain a variety of information associated with the debit card account of the merchant 100. The processors, for example, may be configured to determine the identity of the merchant 110 such as by analyzing the payment request transmitted to the service provider computers 210 from the client device 120. The processors 500 may further receive a personal account number and/or a personal account number proxy identifier from the client device 120 such as within the framework of the payment request received by the service provider computers 210. The processors 500 may convert a received proxy identifier associated with the merchant's debit card account to the debit card account number. Therefore, the credit processing module 520 may enable the processors to analyze various information associated with the payment request and determine a payment receiving debit card account of the merchant 110 to generate a credit transaction. The processors 500 may further generate a credit transaction based upon the one or more information received as part of the payment request. The credit transaction may include debit network information for the debit card as well as a credit amount. In certain embodiments, there may also be a credit delay such as a time period to delay the crediting of the debit account associated with the merchant 110 associated with the generated credit request. The processors 500 may further transmit the generated credit transaction to debit network computers 320 to perform the credit transaction.

The merchant account module 522 may include instructions therein that when executed by processors 500, enable the service provider computers 210 to provide a variety of merchant account management functions. The service provider computers 210 may provide remote electronic collection of payments functionality to a variety of merchants. Therefore, the service provider computers 210 may have a repository of merchants (merchant profiles that may encompass a variety of information associated with each respective merchant) and their associations with their respective debit card accounts for deposit of funds. The processors 500 therefore may be configured to interact with the client device 120 on behalf of the merchant 110 to establish a registration of the merchant 110 with the service provider computers 210 to subsequently enable remote electronic collection of payments. A merchant 110 may be able to interact via his/her client device 120 with the service provider computers 210 and processors 500 thereon to register his/her debit card account as well as subsequently access the service provider computers 210 to make remote deposits of funds. In certain embodiments, the service provider computers and the entities associated therewith may charge the merchant 110 a fee for the use of the remote electronic collection of payments functionality provided by the service provider computers 210. The merchant account module 522 may further include instructions that when executed by the processors 500, enable the service provider computers 210 and the entities associated therewith to levy a fee upon the merchant 110 for the services provided.

It will be appreciated that there may be overlap in the functionality of the instructions stored in the operating system module 512, the application's module 514, the image or information management module 516, the debit processing module 518, the credit indication module 520 and the merchant account module 522. In fact, the functions of the three aforementioned modules 512, 514, 516, 518, 520, 522 may interact and cooperate seamlessly under the framework of the service provider computers 210. Indeed, each of the functions described for any of the modules 512, 514, 516, 518, 520, 522 may be stored in any other module 512, 514, 516, 518, 520, 522 in accordance with certain embodiments of the disclosure. Further, in certain embodiments, there may be one single module that includes the instructions, programs, and/or applications described within the operating system module 512, the application's module 514, the image or information management module 516, the debit processing module 518, the credit indication module 520 and the merchant account module 522.

It will be appreciated that, some of the functions described in association with the service provider computers 210 may be implemented on the client device 120, the item processing computers 220, or in cooperation with the service client device 120 or other elements of architecture 300.

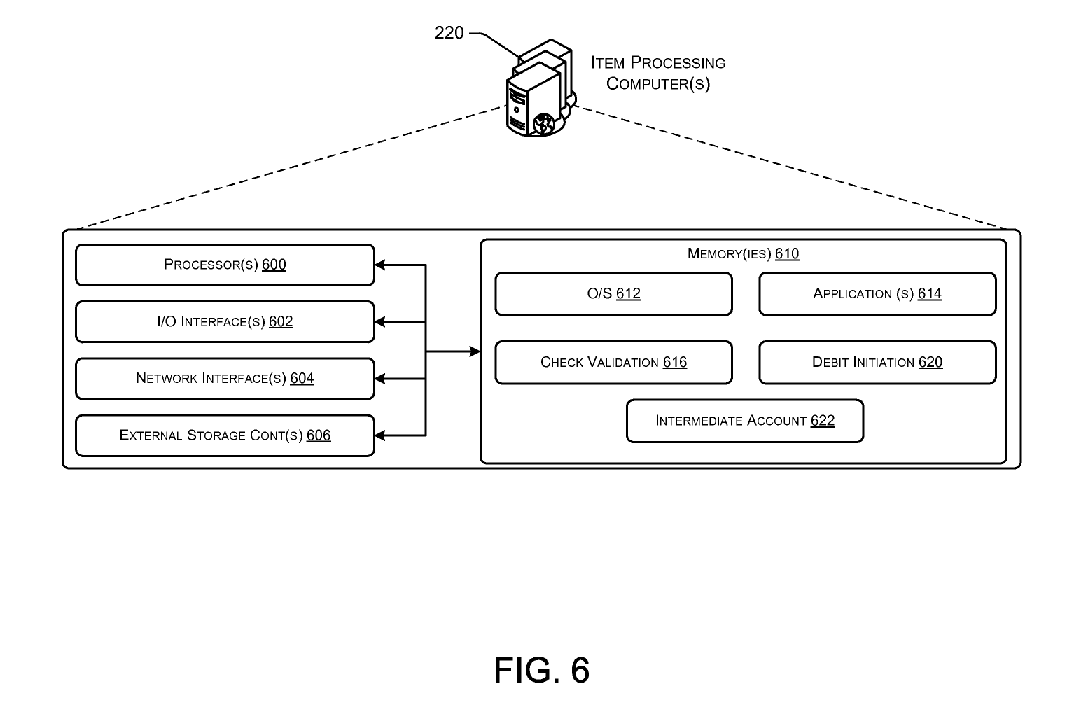

Referring now to FIG. 6, the item processing computers 220 may include a variety of components including processors 600, I/O interfaces 602, network interfaces 604, external storage controllers 606, and memories 610. It will be appreciated that the client devices 120 may include other components or elements that enable the client devices 120 to perform the methods and processes described herein in accordance with embodiments of the disclosure.

The I/O interfaces(s) 602, may include any suitable interface configured to interface between the processors 600 and the components of the item processing computers 220. The network interfaces(s) 604 may allow the item processing computers 220 to communicate with other computing devices or servers, user terminals, and/or other devices on the networks 310 or other suitable communicative channels. The network interfaces(s) 604 may allow the item processing computers 220 to communicate with stored databases. The external storage controllers 606 may enable the processors 600 to communicate with and/or control optional external data stores.

In some examples, the one or more processors 600 of the client device 120 may be implemented as appropriate in hardware, software, firmware, or combinations thereof. Software or firmware implementations of the one or more processors 600 may include computer-executable or machine-executable instructions written in any suitable programming language to perform the various functions described. Hardware implementations of the processors 600 may be configured to execute computer-executable or machine-executable instructions to perform the various functions described. The one or more processors 600 may include, without limitation, a central processing unit (CPU), a digital signal processor (DSP), a reduced instruction set computer (RISC), a complex instruction set computer (CISC), a microprocessor, a microcontroller, a field programmable gate array (FPGA), or any combination thereof. The item processing computers 220 may also include a chipset (not shown) for controlling communications between the one or more processors 600 and one or more of the other components of the item processing computers 220. The one or more processors 600 may also include one or more application specific integrated circuits (ASICs) or application specific standard products (ASSPs) for handling specific data processing functions or tasks.

The memory 610 may include one or more volatile and/or non-volatile memory devices including, but not limited to, random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read only memory (EEPROM), non-volatile RAM (NVRAM), universal serial bus (USB) removable memory, or combinations thereof. The memory 610 may store program instructions that are loadable and executable on the processor(s) 600, as well as data generated or received during the execution of these programs. Turning to the contents of the memory 610 in more detail, the memory 610 may include an operating system module 612, an application's module 614, a check validation module 616, a debit initiation module 620 and an intermediate account module 622. Each of the modules and/or software may provide functionality for the item processing computers 220, when executed by the processors 600. The modules and/or the software may or may not correspond to physical locations and/or addresses in memory 610. In other words, the contents of each of the modules may not be segregated from each other and may, in fact be stored in at least partially interleaved positions on the memory 610. In certain embodiments, each of the modules 612, 614, 616, 618, 620, 622 may be divided with greater granularity. In other words, each of the modules 612, 614, 616, 618, 620, 622 may include sub-modules.

The O/S module 612 may have one or more operating systems stored thereon. The processors 600 may be configured to access and execute one or more of the O/S module 612 to operate the system functions of the item processing computers 220. System functions, as managed by the O/S 612 may include memory management, processor resource management, driver management, application software management, system configuration, and the like. The O/S may be any variety of suitable operating systems including, but not limited to, Google® Android®, Microsoft® Windows®, Microsoft® Windows® Server®, Linux, Apple® OS-X®, Apple® iOS®, or the like. The applications module 614 may have one or more software applications stored thereon that may be accessed and executed by the processors 600 to provide various functionality of the item processing computers 220, including remote deposit related functionality.

The check validation module 616 may include instructions stored thereon that when executed by processors 600, enable the item processing computers 220 to provide a variety of functionality associated with validating a payment instrument, such as a check. In this case, the check may draw upon a demand deposit account (DDA) associated with the payor at the payor's financial institution and the computers 140 associated therewith. The processors 600 may validate one or more elements of the check against each other (e.g., the check number in the MICR line vs. the check number in the upper righthand corner), or validate one or more elements of the check against local or external data repositories (e.g., verify that the routing number is valid). In certain embodiments, the item processing computers 220 and the processors 600 thereon may interact with the payor financial institution computers 140, directly or indirectly, to determine if a payment instrument is valid and/or if there are sufficient funds to clear the payment instrument, such as a check provided as the payment instrument. In other embodiments, the item processing computers 220 may interact with a payment processor computer 330 to determine the sufficiency of funds in a DDA associated with the payment instrument in the form of a check.

The debit initiation module 620 may include instructions therein that when executed by the processor 600, configure the item processing computers 220 to initiate a debit with the payor financial institution computers 140, either directly or via a network, such as a network controlled by the payment processor computers 330, e.g., an ACH network. The debit initiation module 620 may further enable the processor 600 to receive a debit transaction from the service provider computers 210 and process the debit transaction further, in some cases, and provide the same to the payor financial institution computers 140. In some cases, the debit may be performed over an automated clearing house (ACH) system and/or networks. In some cases, the debit transaction may be in the form of an X9.37 file.

The intermediate account module 622 may include instructions thereon that when executed by processor 600, enable the item processing computers 220 to transfer funds from an intermediate financial account associated with the item processing computers 220 to an intermediate financial account associated with the service provider computers 210. Such intermediate financial account processing may be especially useful if the entities controlling the item processing computers 210 and the service provider computers 210 are different entities.

It will be appreciated that there may be overlap in the functionality of the instructions stored in the operating system module 612, the applications module 614, the check validation module 616, the debit initiation module 620, and the intermediate account module 622. In fact, the functions of the three aforementioned modules 612, 614, 616, 620, 622 may interact and cooperate seamlessly under the framework of the item processing computers 220. Indeed, each of the functions described for any of the modules 612, 614, 616, 620, 622 may be stored in any other module 612, 614, 616, 620, 622 in accordance with certain embodiments of the disclosure. Further, in certain embodiments, there may be one single module that includes the instructions, programs, and/or applications described within the operating system module 612, the applications module 614, the check validation module 616, the debit initiation module 620, and the intermediate account module 622.

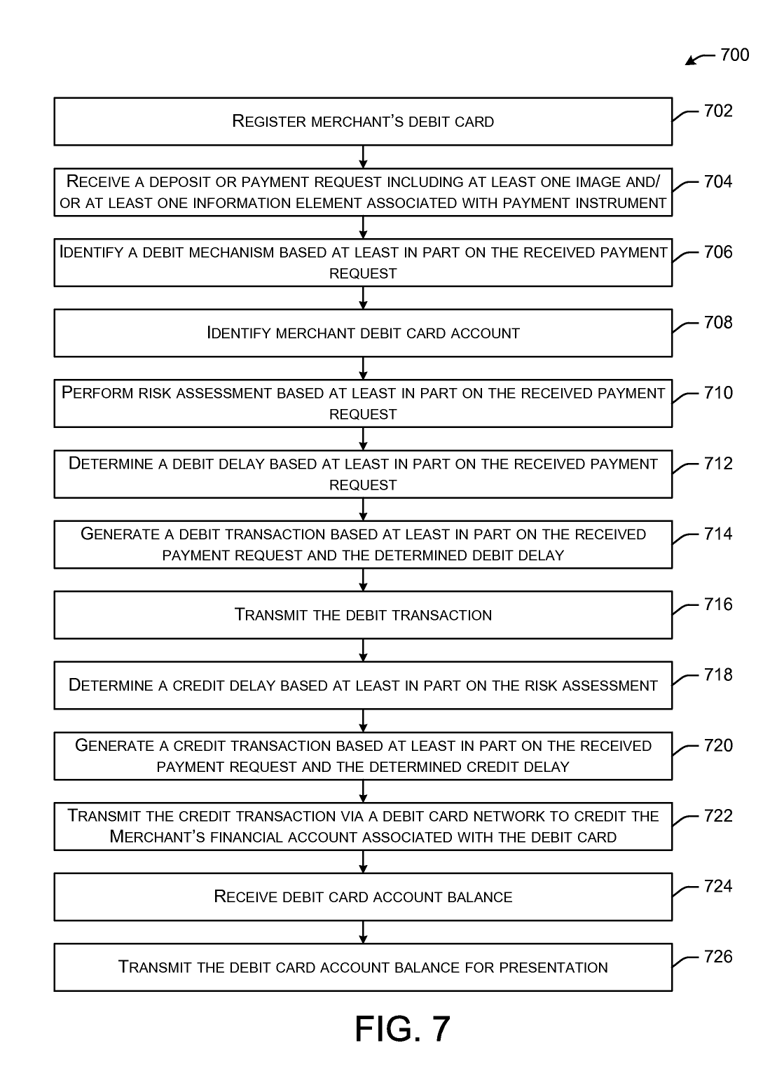

Referring now to FIG. 7, an example method 700 for executing the remote electronic collection of payments in accordance with embodiments of the disclosure is depicted. This method 700 may be executed by the service provider computers 210 in cooperation with other elements of architecture 300. At block 702, a merchant's debit card and associated financial account may be registered with the service provider computers 210. In the process of registering the merchant's debit card, the service provider computers 210 may add the merchant's debit card associated with the merchant to a repository of merchants and their associated debit card accounts (e.g., to a repository of merchant profiles). In one aspect, a particular merchant 110 may have a single debit card account drawing upon a single financial account. In other aspects, a particular merchant 110 may have multiple debits cards associated with multiple financial accounts. The merchant's debit card account may be registered by the service provider computers 210 by interacting with the client device 120 on behalf of the merchant. The merchant via his/her client device 120 may provide the service provider computers 210 with a variety of information related to the debit card and related financial account. This information may include an image of the debit account, debit card and/or a variety of information associated with the debit card. The information may include a personal account number (PAN), a personal identification number (PIN), an expiration date, an issuing financial institution, a network affiliation, a name or the like. In some cases, a PAN proxy (proxy identifier) may be used by the merchant 110 for positive identification with the service provider computers 210. Such a proxy identifier may be associated with a corresponding actual debit card account number in a repository supported by the service provider computers 210. The registration process may also establish authentication credentials with which the merchant 110 using his/her client device 120 may securely identify himself/herself to the service provider computers 210. Therefore, in subsequent interactions with the merchant 110, the service provider computers 210 may identify the merchant 110 based on authentication credentials received from the merchant's client device 120 on behalf of the merchant 110 and accessing the repository of merchants and their associated debit card accounts

At block 704, a deposit or payment request may be received. The deposit or payment request may be received from the client device 120 via the networks 310 or other suitable communicative links. The payment request may further include a variety of information elements and/or images associated with the payment instrument on which the merchant 110 wishes to draw funds. The images associated with a payment instrument within the payment request may include an image of a check or an image of a credit card, an image of a debit card and/or an image of a pre-card or portions thereof. One or more information elements associated with a payment instrument, as supplied by payment request to the service provider computers 210, may include a routing number, an account number, a credit card number, a personal account number, an expiration date, a payment amount, or the like.

At block 706, a debit mechanism may be identified based, at least in part, on the received payment request. In this case, the one or more information elements and/or one or more images associated with the payment request may indicate the mechanism by which the debit is to be performed. For example, if an image of a check is received then it may indicate that the debit mechanism will draw upon a DDA using an ACH mechanism. As another example, if a credit card number is received as part of the payment request then it may be determined that the debit mechanism is credit card account processing. If a debit card number is provided, then that may indicate that the debit mechanism is debit card account processing. If a prepaid card number is presented, then that may indicate that the debit mechanism is prepaid card account processing.

At block 708, the merchant debit card account may be identified. This identification may be based, at least in part, on information received with the payment request of block 704. The debit card account may be identified using a variety of information elements such as a personal account number, a personal account number proxy (proxy identifier), or an identification of the merchant and by accessing a database that links merchant identification to other identifiers of the debit card account. In certain embodiments, the merchant may identify himself/herself by accessing his/her account at the service provider computers 210 via his/her client device 120. Upon identifying, the identity of the merchant 110, the service provider computers 210 may be able to identify the debit card account associated with the merchant 110 by accessing a database of merchant 110 to debit card accounts. As described above, the association between the merchant 110 and his/her debit card account may have been established during the registration process of clock 702.

At block 710, a risk assessment may be performed based, at least in part, on the received payment request. In one aspect, the service provider computers 210 may make an assessment of the likelihood of the debit transaction being performed successfully. This likelihood may be assessed based upon communication with other entities of architecture 300 such as the payor financial institution computers 140. The risk assessment may also be performed by the service provider computers 210 and the processors 500 thereon based, at least in part, on historical data related to the payor or even the particular financial account to be debited. If the payor or the particular financial account to be debited has a history of problematical payment requests (e.g., associated with insufficient funds), then there may be a greater likelihood of risk that the current remote electronic collection of payments may not be consummated. Risk assessment may be performed by comparing attributes of the current remote deposit or payment request with one or more individual pre-established transaction or cumulative transactional limits, historical statistics, or transactional activity volumes.

At block 712, a debit delay may be determined based, at least in part, on the received payment request. In some cases, the debit delay may be based upon the payment instrument having a forward dating requested by the payor. For example, a check may be provided with a date that is at some point in the future and the debit transaction may transpire only when the future date has been reached.

At block 714, a debit transaction may be generated based, at least in part, on the received payment request and the determined debit delay. The debit transaction may provide all the information necessary to initiate a debit from the payor financial institution computers 140. This information may include one or more check images, routing numbers, account numbers, payor identification and a debit amount. In some cases, the debit amount may be the same as the transaction amount as provided in the payment request. In other cases, the debit amount may be different from the transaction amount. The difference may be to collect fees for executing the remote electronic collection of payments. The debit transaction may further include the determined debit delay from block 712. In other words, the debit transaction may indicate a time period that should be transpire before the debit transaction is completed.

At block 716, the debit transaction may be transmitted. The debit transaction may be transmitted from the service provider computers 210 to the item processing computers 220 via the networks 310 or other suitable communicative links The debit transaction may be transmitted as one or more data packets and may include payload information along with overhead such as headers with addresses for directing the data packets and other overhead for conducting transmission integrity checks such as cyclic redundancy checks (CRC) or parity bit checks. In other embodiments, the debit transaction may be transmitted from the service provider computers 210 to the payment processor computers 330 (e.g., to debit a demand deposit account (apart from check or check image processing), a credit card account, a debit card account, or a pre-paid card account). Whether the debit transaction is transmitted to the item processing computers 220 or the payment processor computers 330, a debit instruction will ultimately be transmitted to an appropriate one of the payor financial institution computers 140 to execute a debit of the appropriate financial account.

At block 718, a credit delay may be determined based, at least in part, on the risk assessment as performed in block 710. The credit may be delayed if there is a relatively high risk associated with the transaction for remote electronic collection of payments. In certain embodiments, a credit delay may be implemented so that a debit transaction can be fulfilled prior to crediting the financial account of the merchant 110. The credit delay may be associated with an event (e.g., a notification of the result of debit transaction processing), a period of time, or both.

At block 720, a credit transaction may be generated based, at least in part, on the received payment request and the determined credit delay. This credit transaction may include a variety of information elements associated with the payment instrument. The credit transaction may include a variety of information related to the debit card associated with the merchant 110. This may include the PAN, as determined from the identity of the merchant 110 or a personal account number proxy (PAN proxy). The credit transaction may further include at least an amount to be credited to the merchant's financial account. The credit amount, in certain embodiments, may be the same as the debit amount and the payment amount. In other cases, the credit amount may be different from either the debit amount and/or the payment amount. In some cases, the difference may be to collect fees for conducting the transaction. These fees may be credited to entities associated with the item processing computers 220 and/or the service provider computers 210.

At block 722, the credit transaction may be transmitted to debit network computers 320. A credit instruction will ultimately be transmitted to an appropriate one of the merchant financial institution computers 150 to execute a credit of the appropriate financial account. In alternate embodiments, the credit transaction may be transmitted to a real time payment network other than the debit card network. At block 724, the debit card account balance may be received. This debit card account balance may be transmitted by the merchant financial institution computers 150 to the service provider computers 210 via the debit network computers 320 and networks 310 or other suitable communicative links. At block 726, the service provider computers may transmit the debit card account balance for presentation to the merchant 110. The debit card account balance may be transmitted to the client device 120 for rendering to the merchant 110. As an alternative to the processes of blocks 724 and 726, the service provider computers 210 may receive confirmation of transacting the credit transaction and provide an indication of the same to the client device to render to the merchant 110.

It should be noted, that the method 700 may be modified in various ways in accordance with certain embodiments of the disclosure. For example, one or more operations of the method 700 may be eliminated or executed out of order in other embodiments of the disclosure. Additionally, other operations may be added to the method 700 in accordance with other embodiments of the disclosure.

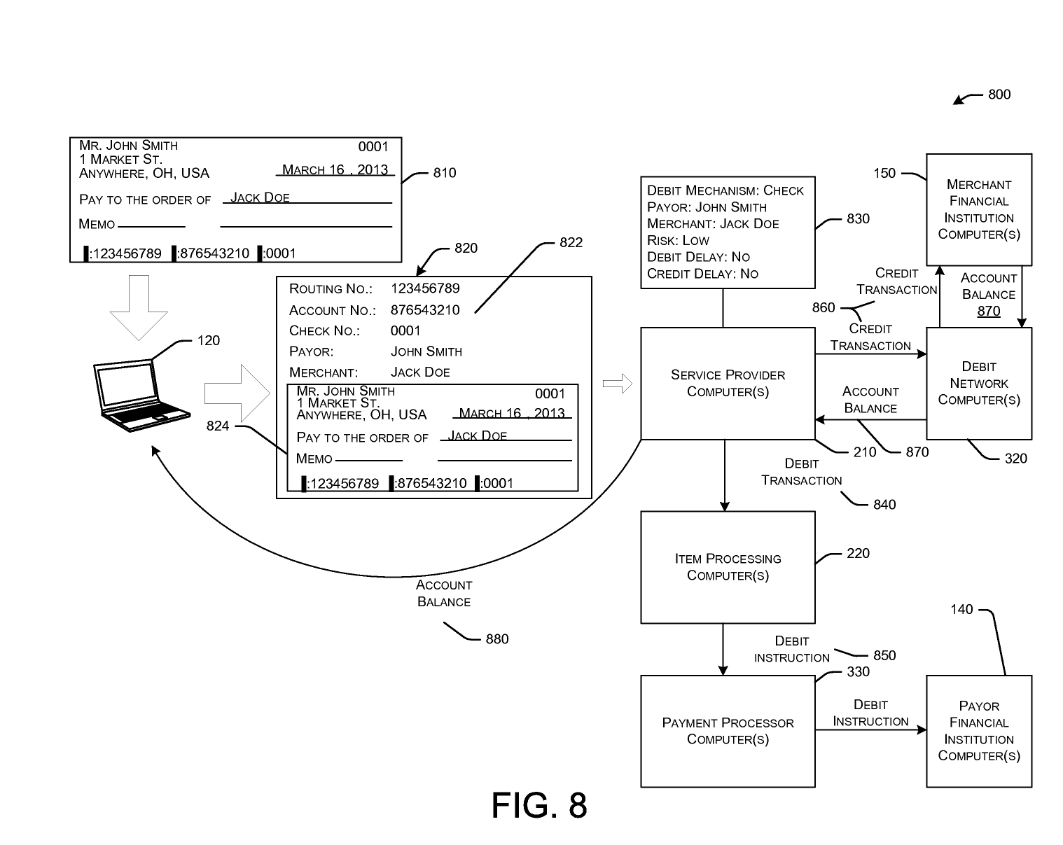

Referring now to FIG. 8, an example scenario 800 of remote electronic collection of payments in accordance with embodiments of the disclosure is depicted. A check 810 may be provided to the merchant 110 for payment and the merchant 110 may generate an image of the check 810 using the client device 120. The client device 120 and the processors 400 thereon may cooperate with a variety of other elements such as input/output device 306 to generate an image 824 of the check 810 to generate a payment request 820. The client device 120 may also extract one or more information elements from the image 824 of the check. These information elements may include a routing number, account number, check number, a payment amount, a payor, and/or a merchant. As shown in FIG. 8 the payment request 820 may accordingly comprise both the information elements 822 and the image of the check 824.

The payment request 820 may be transmitted to the service provider computers 210. The service provider computers 210 may identify the type of debit mechanism as well as the payor, the merchant, and/or other information elements (including the image 824) relevant to at least one of the debit transaction and the credit transaction, may assess a risk associated with the transaction, and may determine if a debit delay or a credit delay should be implemented. FIG. 8 element 830 represents, in an example fashion, the information that may be identified, assessed, and/or determined by the service provide computers 210 based at least in part on the payment request 820. One or more elements of this information 830 derived from the payment request 820 may be transmitted to the item processing computers 220 or used by the service provider computers 210 to generate a debit transaction 840 and a credit transaction 860. The service provider computers 210 upon generating the debit transaction 840 using some or all of the information 830 extracted from or derived based upon the payment request 820 may transmit the debit transaction 840 to the item processing computers 220. The item processing computers 220 may further generate a debit instruction 850 based upon the debit transaction to transmit to the payment processor computers 330 for ultimate propagation (possibly transformed) to an appropriate one of the payor financial institution computers 140. In some embodiments, the item processing computers 220 may transmit the debit instruction 850 directly to the appropriate one of the payor financial institution computers 140.

The service provider computers 210 may further generate the credit transaction 860 using some or all of the information 830 extracted or derived from the payment request 820 and transmit the credit transaction 860 to the debit network computers 320 for ultimate propagation (possibly transformed) to an appropriate one of the merchant financial institution computers 150. In other words, the service provider computers 210 may provide the credit transaction to the debit network computers 320 which may further, ultimately, route the credit transaction to the merchant financial institution computers 150 via a network affiliated with the merchant's debit card. In certain embodiments, the credit transaction may be transmitted directly to the appropriate one of the merchant financial institution computers 150.

The service provider computers 210 may then receive an account balance 870 from the appropriate one of the merchant financial institution computers 150, possibly via the debit network computers 320. In some cases, the service provider computers may solicit the account balance 870 from the appropriate one of the merchant financial institution computers 150, possibly via the debit network computers 320. Therefore, upon requesting and retrieving the account balance 870, the service provider computers 210 may provide this information to the client device 120. The service provider computers 210 may transmit the account balance 880 to the client device 120 as depicted. Upon receiving the account balance 880, the client device 120 may render the same to the merchant 110 providing confirmation of deposit of the payment instrument 810.

Embodiments described herein may be implemented using hardware, software, and/or firmware, for example, to perform the methods and/or operations described herein. Certain embodiments described herein may be provided as a tangible machine-readable medium storing machine-executable instructions that, if executed by a machine, cause the machine to perform the methods and/or operations described herein. The tangible machine-readable medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The machine may include any suitable processing or computing platform, device, or system and may be implemented using any suitable combination of hardware and/or software. The instructions may include any suitable type of code and may be implemented using any suitable programming language. In other embodiments, machine-executable instructions for performing the methods and/or operations described herein may be embodied in firmware.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

While certain embodiments of the disclosure have been described in connection with what is presently considered to be the most practical embodiments, it is to be understood that the disclosure is not to be limited to the disclosed embodiments, but on the contrary, is intended to cover various modifications and equivalent arrangements included within the scope of the claims. Although specific terms are employed herein, they are used in a generic and descriptive sense only, and not for purposes of limitation.

This written description uses examples to disclose certain embodiments of the disclosure and also to enable any person skilled in the art to practice certain embodiments of the disclosure, including making and using any devices or systems and performing any incorporated methods. The patentable scope of certain embodiments of the disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A service provider system, comprising:
one or more memories that stores computer-executable instructions; and
one or more processors configured to access the one or more memories, wherein at least one of the one or more processors is further configured to execute the computer-executable instructions to:
receive, on behalf of a depositor, a deposit request associated with a payment to be deposited, wherein the deposit request includes at least one or more images associated with the payment instrument;
generate a debit transaction comprising one or more of: (i) one or more information elements associated with the payment instrument, or (ii) at least one of the one or more images associated with the payment instrument;
transmit, to one of an item processing system or payment processor system, the debit transaction to initiate a debit of a first financial account with which the payment instrument is associated, wherein the debit is for a first amount associated with an amount of the payment;
identify a debit card account number associated with a second financial account to be credited, wherein the second financial account is associated with the depositor;
generate a credit transaction comprising: (i) an identification of the debit card account number and (ii) an identification of a second amount associated with the amount of the payment; and
initiate a credit of the second financial account by providing the generated credit transaction to a debit network system.

2. The service provider system of claim 1, wherein the payment instrument comprises at least one of: (i) a check; (ii) a credit card; (iii) a debit card; or (iv) a prepaid card.

3. The service provider system of claim 1, wherein the first financial account comprises at least one of: (i) a demand deposit account; (ii) a credit card account; (iii) a debit card account; or (iv) a prepaid card account.

4. The service provider system of claim 1, wherein the one or more information elements comprise at least one of: (i) an identification of a payment instrument type; (ii) an identification of the payer's address; (iii) an identification of the payer's telephone number; (iv) an identification of the financial account; (v) an identification of a financial account number; (vi) an identification of a routing number; (vii) an identification of a check number; (viii) an expiration date; (ix) a card verification string; (x) a card type; (xi) a card association; or (xii) a card issuer.

5. The service provider system of claim 1, wherein the one or more information elements is at least one of: (i) extracted from the one or more images; or (ii) received on behalf of the depositor.

6. The service provider system of claim 1, wherein the at least one of the one or more processors is further configured to extract the amount of the payment from at least one of the one or more images associated with the payment instrument.

7. The service provider system of claim 1, wherein the at least one of the one or more processors is further configured to receiving, on behalf of the depositor, an identifier of the depositor, wherein identifying the debit card account number is based at least in part on the identifier of the depositor.

8. The service provider system of claim 1, wherein the at least one of the one or more processors is further configured to receiving, on behalf of the depositor, a proxy identifier associated with the debit card account number, wherein identifying the debit card account number is based at least in part on the proxy identifier.

9. The service provider system of claim 1, wherein at least one of the first amount or the second amount is equal to the amount of the payment.

10. The service provider system of claim 1, wherein the credit transaction is associated with a credit delay, wherein the credit delay indicates a time delay in crediting the second financial account.

11. The service provider system of claim 1, wherein the at least one of the one or more processors is further configured to associate the debit card account number with the depositor and storing the association in a database.

12. The service provider system of claim 11, wherein the identifying a debit card account number comprises accessing, by the service provider, the database to determine debit card account number associated with one of the depositor or a proxy identifier.

13. The service provider system of claim 1, wherein the at least one of the one or more processors is further configured to:
receiving an account balance of the second financial account; and
transmitting to the client device, the account balance.

14. The service provider system of claim 1, wherein the payment instrument is a check and the debit transaction comprises an image of the check.

15. A method, comprising:
receiving, by a service provider system comprising one or more computers and on behalf of a depositor, a deposit request associated with a payment to be deposited, wherein the deposit request includes one or more images associated with the payment instrument;
generating, by the service provider system, a debit transaction comprising one or more of: (i) one or more information elements associated with the payment instrument, or (ii) at least one of the one or more images associated with the payment instrument;
transmitting, by the service provider system to one of an item processing system or payment processor system, the debit transaction to initiate a debit of a first financial account with which the payment instrument is associated, wherein the debit is for a first amount associated with an amount of the payment;
identifying, by the service provider system, a debit card account number associated with a second financial account to be credited, wherein the second financial account is associated with the depositor;
generating, by the service provider system, a credit transaction comprising (i) an identification of the debit card account number and (ii) an identification of a second amount associated with the amount of the payment; and
initiating a credit of the second financial account by providing the generated credit transaction to a debit network system.

16. The method of claim 15, wherein the payment instrument comprises at least one of: (i) a check; (ii) a credit card; (iii) a debit card; or (iv) a prepaid card.

17. The method of claim 15, wherein the first financial account comprises at least one of: (i) a demand deposit account; (ii) a credit card account; (iii) a debit card account; or (iv) a prepaid card account.

18. The method of claim 15, wherein the one or more information elements comprise at least one of: (i) an identification of a payment instrument type; (ii) an identification of the payer's address; (iii) an identification of the payer's telephone number; (iv) an identification of the financial account; (v) an identification of a financial account number; (vi) an identification of a routing number; (vii) an identification of a check number; (viii) an expiration date; (ix) a card verification string; (x) a card type; (xi) a card association; or (xii) a card issuer.

19. The method of claim 15, wherein the one or more information elements is at least one of: (i) extracted, by the service provider system, from the one or more images; or (ii) received, by the service provider system, on behalf of the depositor.

20. The method of claim 15, further comprising extracting, by the service provider system, the amount of the payment from at least one of the one or more images associated with the payment instrument.

21. The method of claim 15, further comprising receiving, by the service provider system on behalf of the depositor, an identifier of the depositor, wherein identifying the debit card account number is based at least in part on the identifier of the depositor.

22. The method of claim 15, further comprising receiving, by the service provider system on behalf of the depositor, a proxy identifier associated with the debit card account number, wherein identifying the debit card account number is based at least in part on the proxy identifier.

23. The method of claim 15, wherein at least one of the first amount or the second amount is equal to the amount of the payment.

24. The method of claim 15, wherein the credit transaction further comprises a credit delay, wherein the credit delay indicates a time delay in crediting the second financial account.

25. The method of claim 15, further comprising associating, by the service provider system, the debit card account number with the depositor and storing the association in a database.

26. The method of claim 25, wherein the identifying a debit card account number comprises accessing, by the service provider, the database to determine debit card account number associated with the depositor.

27. The method of claim 15, further comprising:
receiving, by the service provider, an account balance of the second financial account; and
transmitting, by the service provider to the client device, the account balance.

28. The method of claim 15, wherein the payment instrument is a check and the debit transaction comprises an image of the check.
